(19) United States
(12) Patent Application Publication
(10) Pub. No.: US 2008/0097836 A1
(43) Pub. Date: Apr. 24, 2008

(54) ADVERTISEMENT PRESENTMENT IN AN ELECTRONIC DEVICE

(76) Inventors: Samuli Silanto, Helsinki (FI); Pertti Tolonen, Vantaa (FI)

Correspondence Address: PERMAN & GREEN, 425 POST ROAD, FAIRFIELD, CT, 06824, US

(21) Appl. No.: 11/551,782

(22) Filed: Oct. 23, 2006

(51) Int. Cl. G06Q 30/00

(52) U.S. Cl. 705/14

(57) ABSTRACT

A method including receiving at least one advertisement in a device and presenting a first information of at least one advertisement in response to the device being activated from an idle state.

### BACKGROUND

1. Field

The disclosed embodiments relate to advertising and, more particularly, to advertising in a mobile device.

2. Brief Description of Related Developments

Advertisements may be sent to a mobile device such as a mobile communication terminal as, for example, short message service (SMS) or multimedia message service (MMS) messages. A network operator or advertiser may include a reply phone number and/or forwarding web link into the message so that the user may respond to the ad when the ad is opened. However, when advertisements are sent to the mobile device via SMS, MMS or other type of message there is no guarantee that a user of the device will read or even look at the ads. There is also very little user interaction with the SMS or MMS advertising messages even though the phone number and/or forwarding web link are added into both message types.

Advertisements that are downloaded for display as a background on a display of the device or as screen savers may also been known but are not widely deployed.

It would be advantageous to display an advertisement so that the advertisement is presented to the user during normal operation of the mobile device in such as way so the user is not frustrated by the presentment of the advertisement.

### SUMMARY

In one embodiment, a method is provided. The method includes receiving at least one advertisement in a device and presenting a first information of at least one advertisement in response to the device being activated from an idle state.

In one embodiment, an apparatus is provided. The apparatus includes a receiver configured to download at least one advertisement, a memory configured to store the at least one advertisement and a processor for causing a first information of the at least one advertisement to be presented in response to the device being activated from an idle state.

In another embodiment, a computer program product is provided. The computer program product includes a computer useable medium having computer readable code means embodied therein for causing a computer to present at least a first information of at least one advertisement. The computer readable code means in the computer program product includes computer readable code means for causing a computer to receive at least one advertisement and computer readable code means for causing a computer to present the first information of the at least one advertisement in response to the device being activated from an idle state.

### BRIEF DESCRIPTION OF THE DRAWINGS

The foregoing aspects and other features of the present embodiments are explained in the following description, taken in connection with the accompanying drawings, wherein:

FIG. 1 shows a schematic illustration of a communication system, as an example in which aspects of the invention may be applied;

FIG. 2 shows a device incorporating features of an embodiment;

FIG. 3 shows another device incorporating features of an embodiment;

FIG. 4 illustrates yet another device incorporating features of an embodiment;

FIG. 5 shows an advertisement in accordance with an embodiment;

FIG. 6 illustrates an advertisement in accordance with an embodiment;

FIG. 6A illustrates an advertisement in accordance with an embodiment;

FIG. 7 illustrates a device incorporating features of an embodiment;

FIG. 8 illustrates a flow diagram in accordance with an embodiment; and

FIG. 9 shows a block diagram of one embodiment of a typical apparatus incorporating features of the aspects of the invention that may be used to practice the aspects of the invention.

### DETAILED DESCRIPTION OF THE EXEMPLARY EMBODIMENT(s)

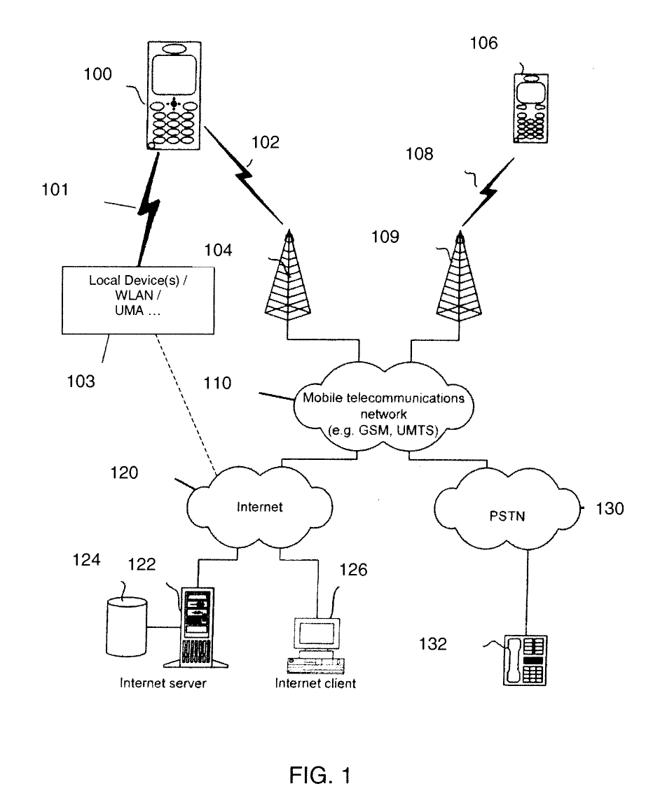

FIG. 1 is a schematic illustration of a telecommunications system, as an example, of an environment in which a communications device 100 incorporating features of an embodiment may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

The number of mobile communication devices in use around the world is ever increasing. As such, mobile communication devices present a significant opportunity for any suitable companies such as advertising companies and the like to present information to a broad range of individuals. Any suitable message or advertising data (i.e. the advertisement) may be sent to the mobile communication devices from any suitable communications interface such as, for example, another mobile device, local devices, or an internet server or internet client. The advertisements may include any suitable informational content such as, for example, items or services for sale, information not related to any type of solicitation, meeting times, public service announcements, employment opportunities and the like. The advertisement may be any suitable advertisement such as advertisements for goods, services and the like. It would be advantageous to provide mobile communication devices and methods for providing the advertisements to users of the mobile devices in such a way so as not to hinder the use of the device. It would also be advantageous to display the advertising information to a user in such a way so the user will be curious as to what information is being presented thereby increasing the efficiency of the advertising.

In the telecommunication system of FIG. 1, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 100 and other devices, such as another mobile terminal 106, a stationary telephone 132, or an internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/hap server capable of serving www/hap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate measurement values to the mobile terminal 100 over the local link 101. The above examples are not intended to be limiting, and any suitable type of link may be utilized. The local devices 103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)).

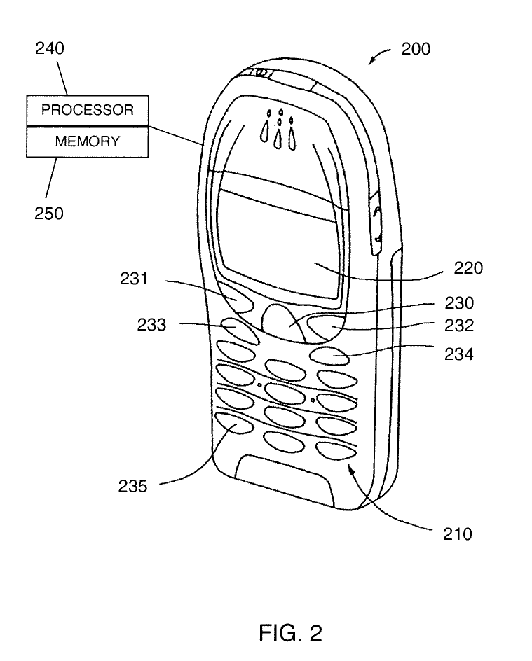

One example of a terminal 100 is illustrated in more detail in FIG. 2. The terminal or mobile communications device 200 may have a keypad 210 and a display 220. The keypad 210 may include any suitable user input devices such as, for example, a multi-function/scroll key 230, soft keys 231, 232, a call key 233 and end call key 234 and alphanumeric keys 235. The display 220 may be any suitable display, such as for example, a touch screen display or graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may also include other suitable features such as, for example, a camera, loud speaker, connectivity port or tactile feedback features. The mobile communications device may have a processor 240 connected to the display for processing user inputs and displaying information on the display 220. A memory 250 may be connected to the processor 240 for storing any suitable information and/or applications associated with the mobile communications device 200 such as phone book entries, calendar entries, etc.

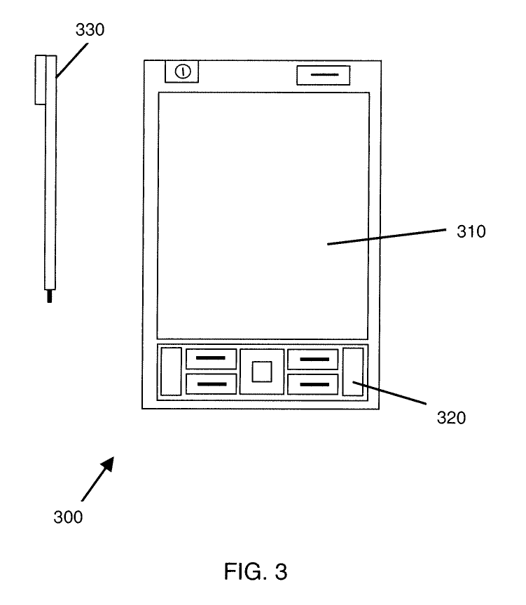

In one example, the device 100, may be for example, a PDA style device 300 illustrated in FIG. 3. The PDA 300 may have a keypad 320, a touch screen display 310 and a pointing device 330 for use on the touch screen display 310. In still other alternate embodiments, the device may be a personal communicator, a tablet computer, a laptop or desktop computer, a television or television set top box, a gaming console or any other suitable device capable of containing the display 220 and supported electronics such as the processor 240 and memory 250. The embodiments herein will be described with reference to the mobile communications device 100 for exemplary purposes only and it should be understood that the embodiments could be applied equally to any suitable device incorporating a display, processor, memory and supporting software or hardware.

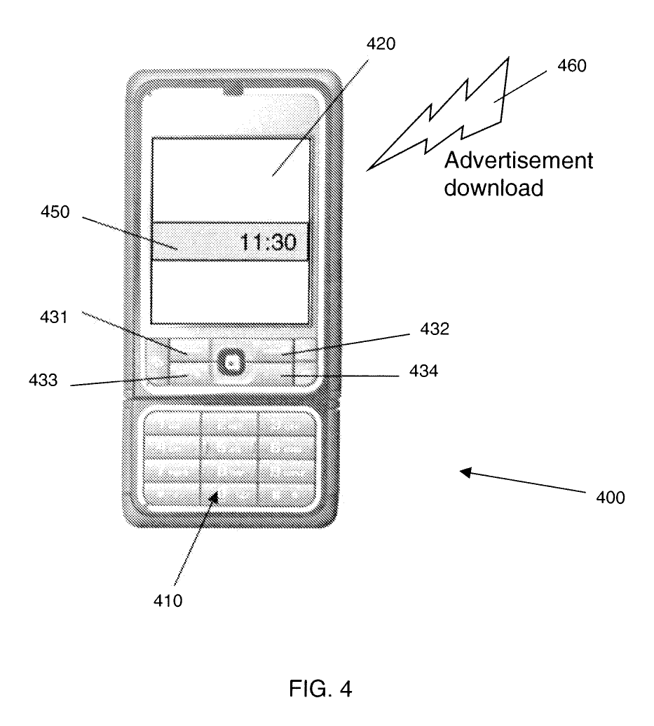

Referring now to FIG. 4, a mobile communications device or terminal 400 is shown. The mobile terminal 400 may be substantially similar to devices 100, 200 described above and may include a display 420 and keypad 410. The keypad 410 may include any suitable user input devices such as, for example, soft keys 431, 432, a call key 433 and end call key 434 and alphanumeric keys. The mobile terminal of FIG. 4 is shown as being in an idle state. Examples of when the phone is in an idle state include when the user is not operating the terminal, when the keys on the keypad 410 are locked from use, when the mobile terminal is a mode of decreased power consumption or a sleep mode for extending the battery life of the phone. When the phone is in an idle state, for example, the display 420 may be shut off, present a blank or colored screen, activate a portion of the screen and the like. In other examples, a screen saver may be presented on the display 420. The screen saver may be any suitable screen saver such as a picture, text, a video, an animated image, a moving symbol, an icon, etc. In the example shown in FIG. 4, the screen saver is shown as a time display bar 450 that may, for example, move up and down on the screen. In alternate embodiments any suitable screen saver may be utilized. The screen saver may be activated when, for example, the terminal 400 enters the idle state or when a user activates the screen saver.

The mobile device 400 may be configured to receive at least information related to an advertisement(s) from any suitable source as described above. The mobile terminal 400 may be configured to receive or download 460 the advertisement information through for example, any suitable communications protocols such as cellular protocols, internet protocols, SMS, MMS, Bluetooth, infrared, etc. Information related to the advertisement(s) may be displayed in any suitable area of the display 420 including, but not limited to, in a portion of the screen saver, displayed as the screen saver or background of the display 420 and the like. Examples pertaining to the display of the advertising information will be described in greater detail below.

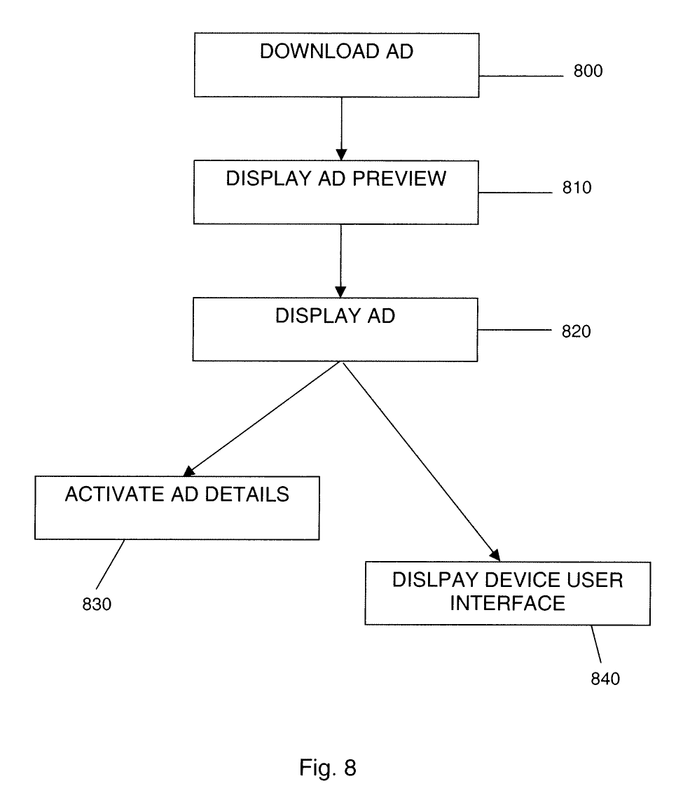

The mobile terminal 400 may be configured to receive or download the advertising information at any suitable time. Examples of when the terminal 400 may receive or download the advertising information include, but are not limited to when the terminal is in use or in an idle state, when the terminal is in an active state (e.g. in use) or upon request from a user of the terminal. The mobile terminal 400 may also be configured to store any suitable number of downloaded advertisements in the memory 250 of the mobile terminal 400 (Block 800, FIG. 8) for later retrieval and presentment to a user of the mobile terminal 400.

In one embodiment, the advertising information is downloaded to the device. A portion of the advertisement or a descriptive aspect related to the advertisement can be displayed or presented to the user. For example, in one embodiment an advertising message is downloaded to the terminal 400 while the terminal 400 is in an idle mode. In alternate embodiments, the advertising information can be downloaded at any suitable time. A descriptive aspect or portion of the advertising information is displayed to the user while the device remains in the idle mode. The descriptive aspect of the advertising information may include text, graphics, animations, video, audio, symbols, interactive menu or any other suitable indicator related to the advertising information.

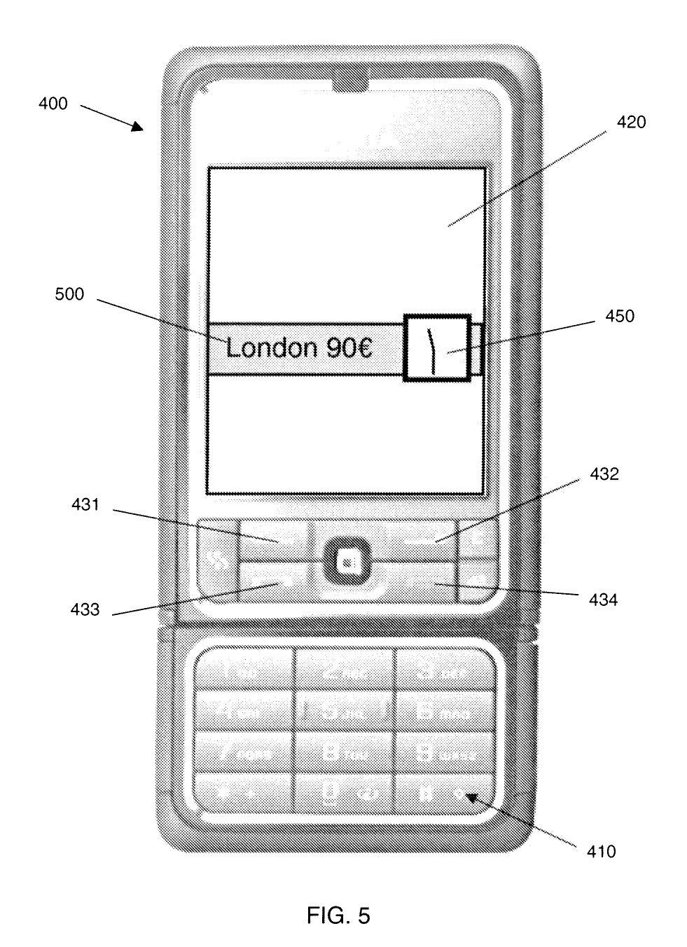

Referring to FIG. 5, advertisement information related to a trip to London has been received in the device 400. To interest the user in and inform the user of the advertisement an information segment 500 can be displayed that is related to the downloaded advertisement information. The information segment may be any suitable segment such as for example, an active line of partial mode display. In this example, the information segment 500 informs the user of the trip to London and its associated cost. The information segment 500 may remain displayed until the terminal 400 is activated from the idle mode. In alternate embodiments, the information segment 500 may be displayed for a predetermined amount of time. In other alternate embodiments the information segment 500 may alternate between different advertising information stored in the memory 250. For example, the information segment 500 may alternate between information relating to the advertisement for the trip to London and a trip to Florence where each advertisement is displayed for a predetermined amount of time in an alternating or cyclical manner. In still other alternate embodiments any suitable advertising information may be displayed in the information segment 500. In other alternate embodiments the terminal may be configured to allow a user to stop the display of the advertising information without exiting the idle mode.

The terminal may include any suitable hardware or software for processing the received or downloaded advertising information. In one embodiment, the processor 240 may process the downloaded advertisement information and extract information from, for example, any suitable part of the advertising message (e.g. the message header, the body of the message, etc.) for display on the terminal 400. In one embodiment, the information segment 500 may be displayed in any suitable area of the display such as, for example, in a status bar presented on the display 420, a soft key function and the like. In the example shown in FIG. 5, the information segment 500 is displayed in a partial mode display such as, for example, the screensaver of the device 400. The screen saver may be any suitable screen saver as described above.

In FIG. 5, the screen saver is illustrated as a time display bar 450 but may be any suitable screen saver feature such as, for example, an icon that moves or floats over the display screen or a stationary screen saver feature. The processor may cause a portion of the advertising information such as the information segment 500, relating to the advertisement, to be displayed on the terminal 400 (Block 810, FIG. 8). In this example, the information segment 500 is displayed in the time display bar 450 of a screen saver. In other embodiments, the information segment 500 may be displayed in any suitable area of the display. In alternate embodiments, a portion of the advertising information that falls under the position of, for example a stationary or moving feature of the screen saver, may be vaguely displayed to the user so that the stationary or moving screen saver feature acts as a type of “search light” or “window” that allows for partial viewing of the advertisement (e.g. allowing a user to see through the screen saver via a window to view the portion of the advertisement under the window) which makes the user curious to find out what information the advertisement conveys. In other alternate embodiments the information segment related to the advertisement may be presented to the user in any suitable manner. This partial mode advertisement may increase the effectiveness of the mobile device advertising as will be described below. In addition, the partial mode advertising via, for example, the screensaver does not affect the power consumption of the terminal 400 because the power saving characteristics of the partial mode display (e.g. screen saver) is maintained. In alternate embodiments, a more complete version of the advertising information may be displayed in the screensaver. In addition, a moving screen saver feature such as the moving bar 450 may not be as annoying as the presentment of full screen graphics while the mobile terminal is in the idle mode.

In one embodiment, the background lighting of the display and keys can be used to inform the user that an advertising information has been received in the mobile terminal 400. In another embodiment, the background lighting such as, for example, the back-lighting of the keys on the keypad 410 of the mobile terminal may be turned off while the mobile terminal is inactive and the partial mode advertisement is presented. In still another embodiment the background lighting may be turned on or may flash for a predetermined amount of time to indicate an advertisement has been received and is being displayed in a partial mode. In alternate embodiments an audible indicator may sound to alert the user to the receipt of the advertisements in the mobile terminal.

In one embodiment additional advertising information may be presented or displayed to the user (Block 820, FIG. 8). The additional advertising information may include a more detailed description of the advertisement than that shown in the information segment 500. For example, the additional advertising information may be displayed or presented when the terminal 400 is activated from the idle mode. In other embodiments any suitable event in the device may cause the display of the additional advertising information such as, for example, when a user requests the viewing of the additional information. In one embodiment, when the terminal 400 exits or is activated from the idle mode the user may be presented with options for viewing the additional advertising information. The options may be presented to the user in any suitable manner such as through, for example, a key of the terminal 400 or through a touch on a touch screen. In another embodiment, the additional information may be automatically displayed when for example, the device exits the idle mode or when the user unlocks the keypad. In still other embodiments, additional information related to the advertisement may be displayed after a delay. The delay may be user settable, defined in the advertising message, or defined by a system administrator (e.g. mobile communications operator, web site operator, etc.). In alternate embodiments the delay may be specified in any suitable manner.

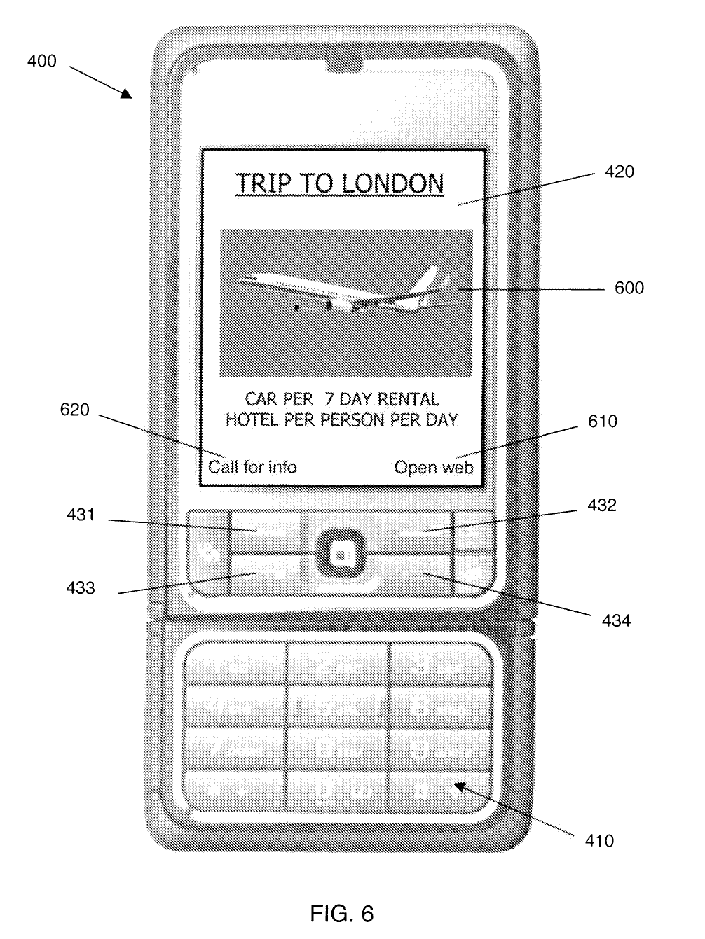

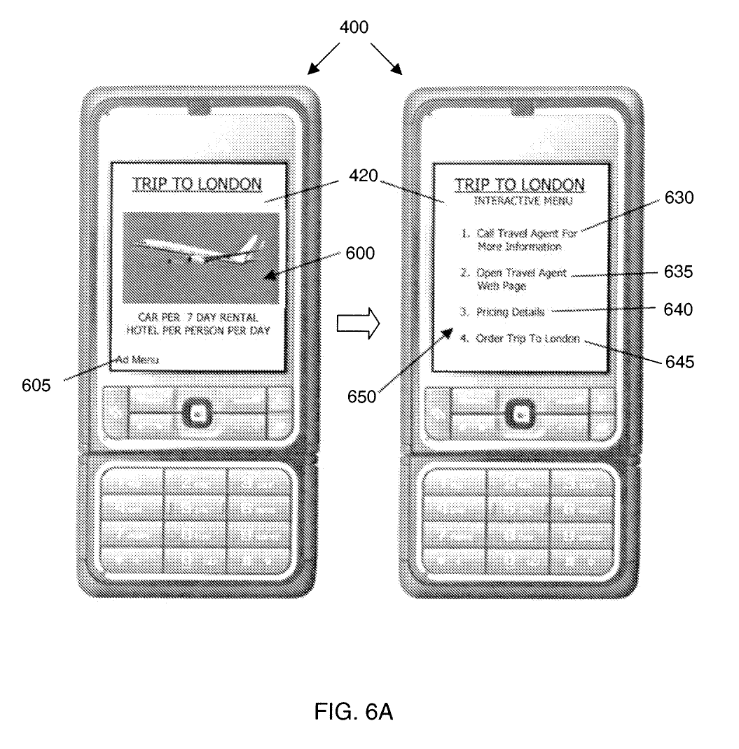

Referring to FIG. 6, advertisement options 610, 620 may be presented to the user when the additional information is displayed. The advertisement options may be any suitable options to, for example, obtain more information about the advertisement, contact the advertiser, order the products or services advertised, stop the display of the additional advertising information, etc. (Block 830, FIG. 8). The advertisement options 610, 620 may be custom functions pertaining to the advertisement that may be associated with keys of the terminal 400 such as the soft keys 432, 431. In alternate embodiments any suitable key or section on the touch screen display (if the device is so equipped) may be associated with the advertisement options. The advertisement options 610, 620 may allow the user to react to the additional advertising information 600 by, for example, opening a web page or calling the advertiser for more information about the offer presented by the advertisement. In alternate embodiments, any suitable functions related to the advertisement may be associated with the soft keys. These advertisement options may open a direct communication line or contact with the advertising company. In other embodiments a joystick, directional pad and the like may be utilized to interact with the advertising material. For example, the user may press or otherwise manipulate the key, joystick etc. to access an interactive menu 650 pertaining to the advertisement as can be seen in FIG. 6A. The menu 650 may be accessed in any suitable manner such as by selecting a menu option 605 using the key, joystick, etc. The menu may include alternative actions that are displayed on the display of the terminal 400. The alternative actions may include any suitable action such as, for example, calling a travel agent for more information 630, opening a web page 635, information pertaining to pricing 640 and ordering the trip 645. The actions 630-645 are displayed in FIG. 6A as a numbered list but in alternate embodiments the menu may have any suitable form including animations, graphics, etc.

In one embodiment, the additional advertising information 600 may be displayed to the user for a predetermined amount of time (i.e. advertising period) so as not to interfere with the normal operation of the mobile terminal 400. The predetermined amount of time may be any suitable amount of time. In this example, the predetermined amount of time is less than one second. In alternate embodiments, the predetermined amount of time may be equal to or greater than one second. If the user does not request more information pertaining to the advertisement 600 the additional advertising information may be removed from the display (Block 840, FIG. 8). The predetermined amount of time may be set in any suitable manner. For example, the predetermined period of time may be user definable or it may be specified in part of the advertising information received or downloaded by the terminal 400. In other embodiments, the additional advertising information may be displayed to the user until the user either selects one of the options 610-645 or until the user stops the display of the advertising information. The user may stop the display of the advertising information in any suitable manner such as, for example, by pressing or manipulating, for example, a suitable key, directional pad, joystick, etc. of the terminal 400.

In one embodiment, after the predetermined period has expired and the advertising information is removed from the display the advertising information may also be removed from the memory 250 of the terminal so that the advertisement can not be revisited or viewed again by the user. In other embodiments the advertisement may be stored in the memory 250 of the terminal 400 so that a user may access the advertisement after the predetermined period expires through, for example, a corresponding user interface function. In other embodiments the advertisement may be stored in the memory 250 of the terminal 400 for a period of time after which the advertisement is deleted form the memory 250.

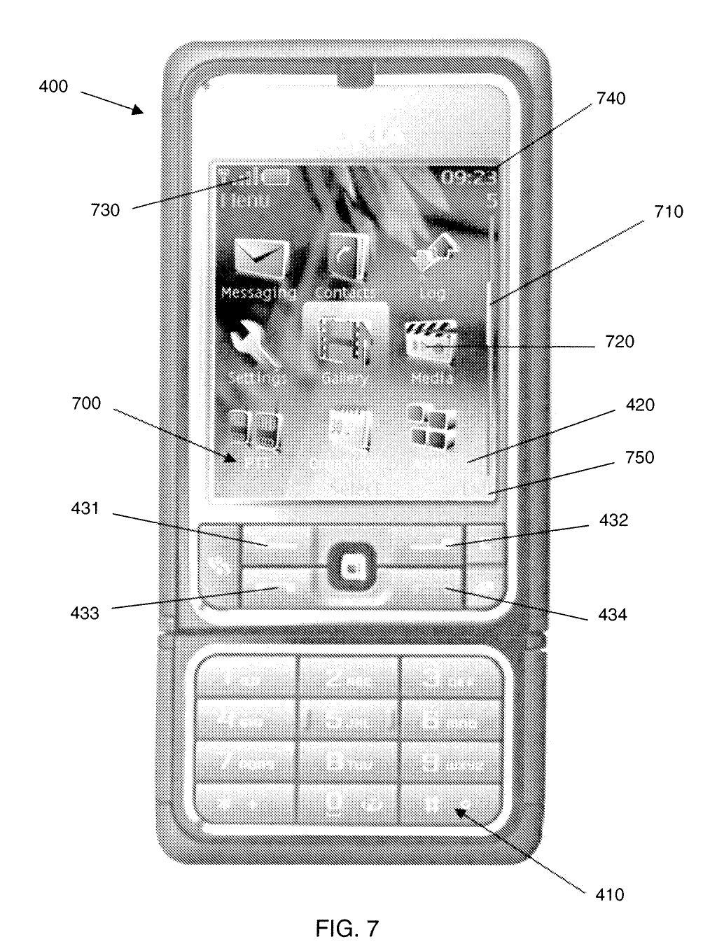

Any suitable display screen may be presented to the user after the advertising period. An exemplary user interface display screen 700 that may be displayed after the advertising period is shown in FIG. 7. The user interface may include the time 740, signal and battery strength indicators 730, a slide bar 710, soft key functions 750 and icons or links 720 to applications or functions (e.g. music players, internet, television, calendars, etc.) of the mobile terminal. The user interface may also include a menu in which the user can customize how the advertisements are presented. For example, the user may specify where the advertisement preview is presented in the screensaver when the mobile terminal is in a partial screen mode, the user may specify how long the advertisement is to be presented to the user when the screen saver is turned off or the mobile terminal is otherwise returned to an active state or the user may select which available customized functions may be associated with the soft keys 432, 431.

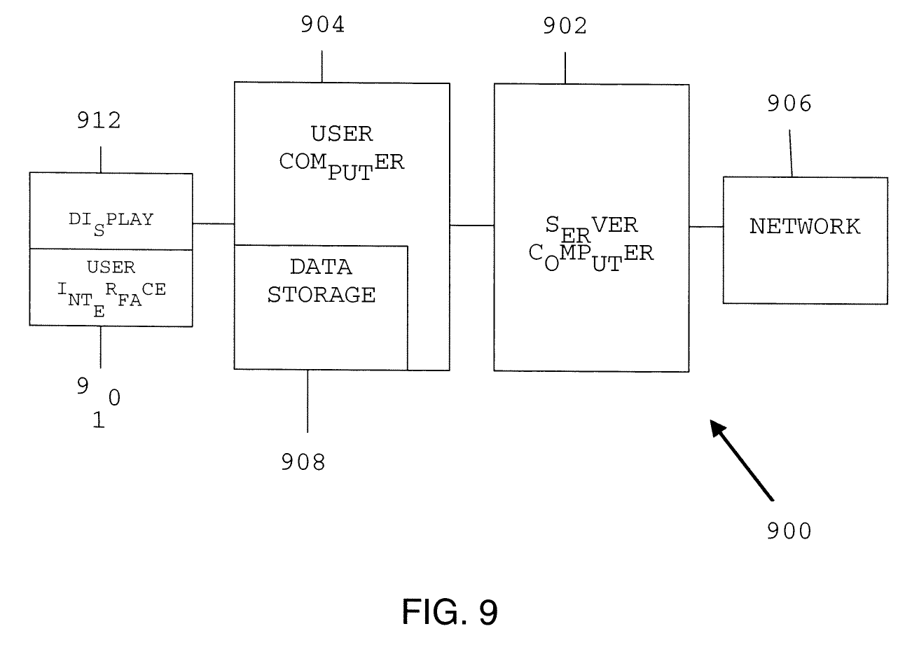

The disclosed embodiments may also include software and computer programs incorporating the process steps and instructions described above that are executed in different computers. FIG. 9 is a block diagram of one embodiment of a typical apparatus 900 incorporating features that may be used to practice the present invention. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, hard wire connection, or fiber optic link. Generally, information can be made available to both computer systems 902 and 904 using a communication protocol typically sent over a communication channel or through a dial-up connection on ISDN line. Computers 902 and 904 are generally adapted to utilize program storage devices embodying machine readable program source code, which is adapted to cause the computers 902 and 904 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 902 may include a data storage device 908 on its program storage device for the storage of information and data. The computer program or software incorporating the processes and method steps incorporating features of the present invention may be stored in one or more computers 902 and 904 on an otherwise conventional program storage device. In one embodiment, computers 902 and 904 may include a user interface 910, and a display interface 912 from which features of the present invention can be accessed. The user interface 910 and the display interface 912 can be adapted to allow the input of queries and commands to the system, as well as present the results of the commands and queries.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
receiving at least one advertisement in a device;
presenting a first information of at least one advertisement in response to the device being activated from an idle state.

2. The method of claim 1, wherein the at least one advertisement is a visual, text, audio, video and/or graphics indication.

3. The method of claim 1, further comprising displaying the first information of the at least one advertisement for a predetermined period of time.

4. The method of claim 3, wherein the predetermined period is less than about one second.

5. The method of claim 3, further comprising removing the first information of the at least one advertisement from a display of the device.

6. The method of claim 5, further comprising allowing a user to access user interface functions of the device.

7. The method of claim 3, further comprising selecting the first information of the at least one advertisement for user interaction, viewing and/or transactions.

8. The method of claim 3, wherein the at least one advertisement cannot be revisited after the predetermined period of time expires.

9. The method of claim 8, wherein the at least one advertisement is removed from a memory of the device.

10. The method of claim 3, further comprising storing the at least one advertisement in a memory of the device so a user can access the at least one advertisement after the predetermined period of time expires.

11. The method of claim 10, wherein the stored advertisement can be revisited by the user by selecting a corresponding user interface function.

12. The method of claim 1, further comprising displaying a second information of the at least one advertisement when the device is in the idle state.

13. The method of claim 12, wherein the second information of the at least one advertisement is associated with the first information of the at least one advertisement.

14. The method of claim 12, wherein the second information of the at least one advertisement is displayed in a partial mode display of the idle state.

15. The method of claim 12, wherein the second information of the at least one advertisement is part of the first information of the at least one advertisement.

16. The method of claim 15, wherein the second information is based on the active lines in the partial mode display at a given time instance.

17. The method of claim 15, wherein the second information of the at least one advertisement is different based on the place the active lines are positioned in the partial mode display so that the second information allows for the presentation of different parts of the first information of the at least one advertisement to the user.

18. The method of claim 12, wherein the displaying of the second information of the at least one advertisement is independent of the displaying of the first information of the at least one advertisement in a partial mode display of the idle state.

19. An apparatus comprising:
a receiver configured to download at least one advertisement;
a memory configured to store the at least one advertisement; and
a processor for causing a first information of the at least one advertisement to be presented in response to the device being activated from an idle state.

20. The apparatus of claim 19, wherein the at least one advertisement is a visual, text, video, audio and/or graphics indication.

21. The apparatus of claim 19, wherein the processor is further configured to display the first information of the at least one advertisement for a predetermined period of time.

22. The apparatus of claim 21, wherein the predetermined period is less than about one second.

23. The apparatus of claim 21, wherein the processor is further configured to remove the first information of the at least one advertisement from a display of the device.

24. The apparatus of claim 23, wherein the processor is further configured to allow a user to access user interface functions of the device.

25. The apparatus of claim 21, wherein the processor is further configured to allow a user to select the first information of the at least one advertisement for user interaction, viewing and/or transactions.

26. The apparatus of claim 21, wherein the at least one advertisement cannot be revisited after the predetermined period of time expires.

27. The apparatus of claim 26, wherein the processor is further configured to remove the at least one advertisement from the memory of the device.

28. The apparatus of claim 21, wherein the at least one advertisement is stored in the memory so a user can access the at least one advertisement after the predetermined period of time expires.

29. The method of claim 28, wherein the processor is further configured to allow a user to revisit the stored at least one advertisement by selecting a corresponding user interface function.

30. The apparatus of claim 19, wherein the processor is further configured to display a second information of the at least one advertisement when the device is in the idle state.

31. The apparatus of claim 30, wherein the second information of the at least one advertisement is associated with the first information of the at least one advertisement.

32. The apparatus of claim 30, wherein the second information of the at least one advertisement is part of a partial mode display of the idle state.

33. The apparatus of claim 30, wherein the second information of the at least one advertisement is part of the first information of the at least one advertisement which is based on the active lines in the partial mode display at a given time instance.

34. The apparatus of claim 33, wherein the second information of the at least one advertisement is different based on the place the active lines are positioned in the partial mode display so that the second information allows for the presentation of different parts of the first information of the at least one advertisement to the user.

35. The apparatus of claim 30, wherein the display of the second information of the at least one advertisement is independent of the displaying of the first information of the at least one advertisement in a partial mode display of the idle state.

36. A computer program product comprising:
a computer useable medium having computer readable code means embodied therein for causing a computer to present at least a first information of at least one advertisement, the computer readable code means in the computer program product comprising:
computer readable code means for causing a computer to receive at least one; and
computer readable code means for causing a computer to present the first information of the at least one advertisement in response to the device being activated from an idle state.
